(19) United States
(12) Patent Application Publication
(10) Pub. No.: US 2011/0125548 A1
(43) Pub. Date: May 26, 2011

(54) BUSINESS SERVICES RISK MANAGEMENT

(76) Inventors: Michal Aharon, Haifa (IL); Hadas Kogan, Zichron Yaacov (IL); Eliav Levi, Even Yehuda (IL)

(21) Appl. No.: 12/625,780

(22) Filed: Nov. 25, 2009

(51) Int. Cl. G06Q 10/00

(52) U.S. Cl. 705/7.28

(57) ABSTRACT

A business service model includes a description of a topology of interconnections between configuration items that implement a business service. Each of the configuration items is associated with a respective vulnerability score and a respective type classification. Based on the vulnerability scores and the type classifications, the following values are determined for each of the configuration items: a respective activity level value indicating a probability of the configuration item being active in the business process, a respective vulnerability probability value indicating a probability of the configuration items being compromised and damaged in the business process, and a respective business process risk value indicating a probability of a failure of the business process resulting from damage of the configuration item. The business process is scored based on the activity level values, the vulnerability values, and the business process risk values.

### CROSS-REFERENCE TO RELATED APPLICATIONS

This application relates to the following co-pending applications, each of which is incorporated herein by reference: U.S. patent application Ser. No. 12/250,199, filed Oct. 13, 2008; and U.S. patent application Ser. No. 12/361,279, filed Jan. 28, 2009.

### BACKGROUND

In today's technological environment, the complexity and connectivity between information technology (IT) assets are increasing and changing at a rapid rate, leading to an increase in the numbers of system vulnerabilities. Left undetected or improperly corrected, these vulnerabilities provide an open door for network attacks which can devastate an organization's IT infrastructure. Within the enterprise environment huge amounts of data make the security situation impossible to perceive by humans. What is needed are improved systems and methods of managing business services risk.

### DESCRIPTION OF DRAWINGS

FIG. 1 is a block diagram of an embodiment of a business services risk management system.

FIG. 2 is a flow diagram of an embodiment of a business services risk management method.

FIG. 3A is diagrammatic view of an embodiment of a window of a graphical user interface.

FIG. 3B is diagrammatic view of an embodiment of a window of a graphical user interface.

FIG. 4 is a block diagram of an embodiment of the business services risk management system of FIG. 1.

FIG. 5 is a block diagram of an embodiment of a computer system that incorporates an embodiment of the business services risk management system of FIG. 1.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. Definition of Terms

A “computer” is any machine, device, or apparatus that processes data according to computer-readable instructions that are stored on a computer-readable medium either temporarily or permanently. A “computer operating system” is a software component of a computer system that manages and coordinates the performance of tasks and the sharing of computing and hardware resources. A “software application” (also referred to as software, an application, computer software, a computer application, a program, and a computer program) is a set of instructions that a computer can interpret and execute to perform one or more specific tasks. A “data file” is a block of information that durably stores data for use by a software application.

A Configuration Management Database (CMDB) is a particular type of repository (e.g., a database) in accordance with the Information Technology Infrastructure Library (ITIL) definition published at the ITIL library (see, e.g., http://www.itil-officialsite.com/home/home.asp). A CMDB stores business service models. Each business service model includes a description of a topology of interconnections between configuration items (CIs) that implement a business service. It should be noted that the terms “IT asset”, “CI”, and “node” are used interchangeably throughout the disclosure and are intended to denote any IT asset of an organization (in accordance with the ITIL definition). A CI may be any type of system resource, including hardware, software, facilities, documents, services, processes, and human resources. Exemplary types of CIs include computers, software applications, routers, network connections, private branch exchanges (PBXs), automatic call distributors (ACDs), printers, telephones, and any other technological asset associated with an organization.

A business service is service that is offered by a computer system that performs a set of functions on demand. Business services directly support the ongoing operations of a business or the products and services that customers consume from the business (e.g., customer support, order processes, payroll, etc.). The computer system is a set of IT assets whose relationships are defined by a set of CIs stored in a CMDB. Each business service typically is assigned a criticality grade that reflects its importance to the business. A business service model may include other business services models within itself (i.e., sub-sets). For example, a business service model related to “online banking” may include other business service models, such as “account services,” “transferring funds,” and “bill payment.” Accordingly, business services models may be structured hierarchically, where a single business service model may include a plurality of other business service models, and each business service model includes a respective set of CIs.

As used herein, the term “includes” means includes but not limited to, the term “including” means including but not limited to. The term “based on” means based at least in part on.

### II. Managing Business Services Risk

A. Overview

The embodiments that are described herein provide improved systems and methods of managing business services risk that fuses business services data and creates a reliable and simple representation of the security situation. These embodiments leverage a unique probabilistic framework that combines business service topology structure with security measures and provides for each business service a single respective risk metric that represents the security level of the business service. In some of these embodiments, the probabilistic framework is used to determine a ranking of the configuration items of the business service and determine the most urgent security critical missions.

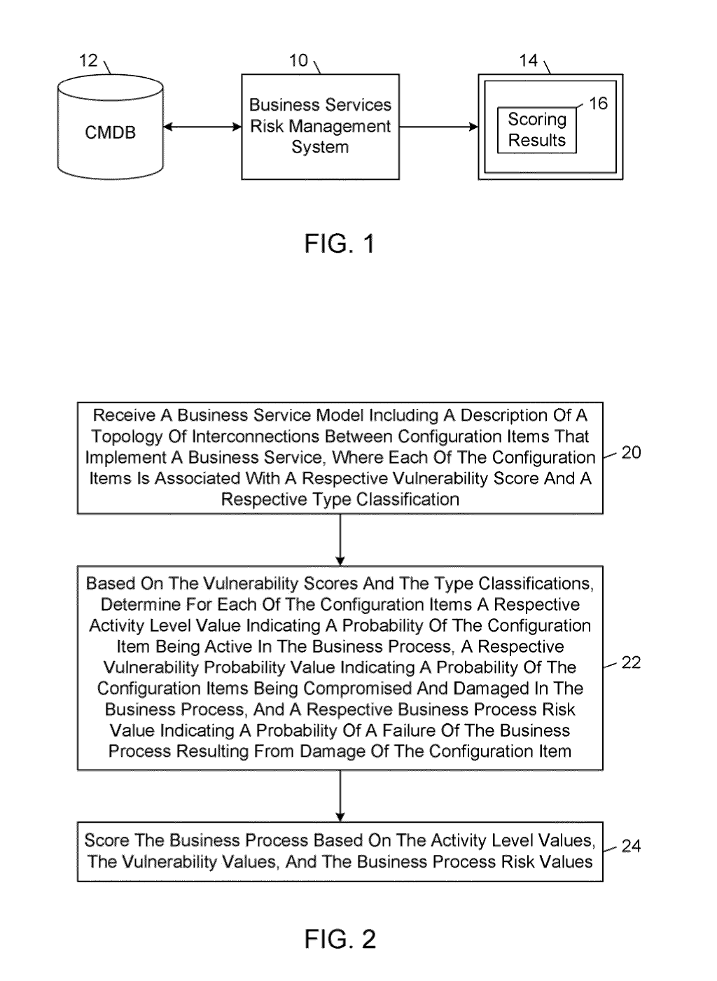

FIG. 1 shows an embodiment of a business services risk management system 10 that is electronically coupled to a configuration management database (CMDB) 12. In operation, the business services risk management system 10 scores one or more business services based on the business service model information contained in the CMDB 12 and presents the results of the scoring in a graphical user interface 16 on a display 14.

FIG. 2 shows an embodiment of a method that is implemented by the business services risk management system 10. The business services risk management system 10 receives from the CMDB 18 a business service model that includes a description of a topology of interconnections between configuration items that implement a business service, where each of the configuration items is associated with a respective type classification and a respective vulnerability score (FIG. 2, block 20). The vulnerability scores may be contained in the CMBD 18 or they may be determined by the business services risk management system 10. Based on the vulnerability scores and the type classifications, the business services risk management system 10 determines for each of the configuration items a respective activity level value indicating a probability of the configuration item being active in the business service, a respective vulnerability probability value indicating a probability of the configuration items being compromised and damaged in the business service, and a respective business service risk value indicating a probability of a failure of the business service resulting from damage of the configuration item (FIG. 2, block 22). The business services risk management system 10 scores the business service based on the activity level values, the vulnerability values, and the business service risk values (FIG. 2, block 24).

In some embodiments, the business services risk management system 10 derives a risk score from the activity level values, the vulnerability values, and the business service risk values, where the risk score indicates a probability of the business service being damaged. In some of these embodiments, the business services risk management system 10 determines a respective risk score for a given business service and additionally ranks the configuration items in accordance with their respective contributions to the score of the business service.

The business services risk management system 10 typically presents the risk scores and the configuration item rankings in the graphical user interface 16 on the display 14.

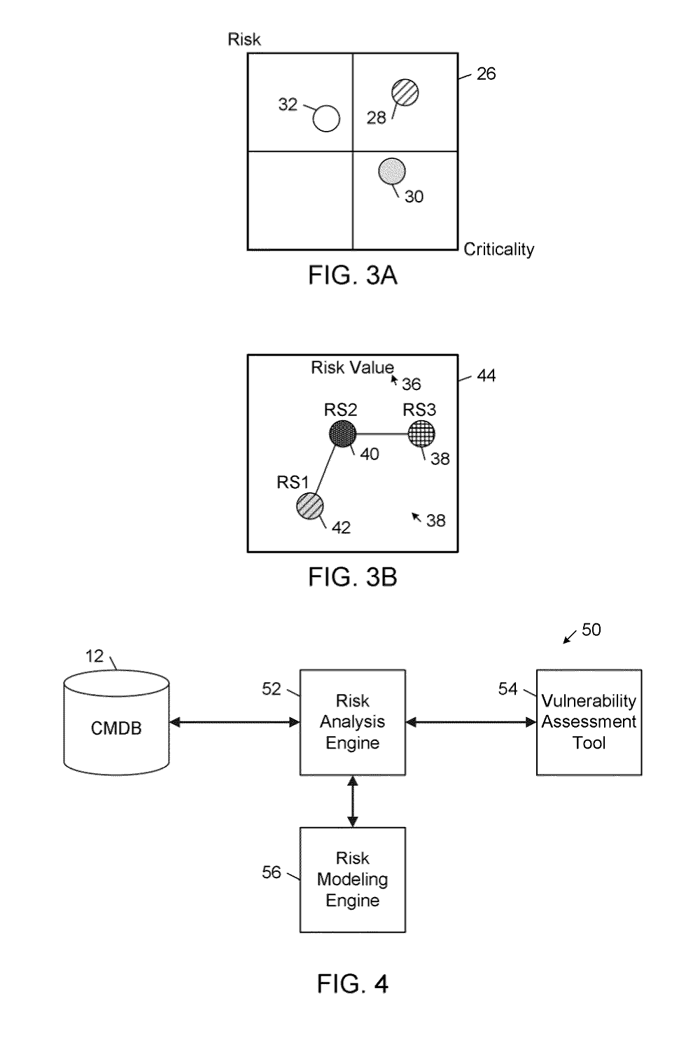

Referring to FIG. 3A, in some embodiments, the business services risk management system 10 presents the risk scores of multiple business services (e.g., account services, transfer funds, and bill payment) as a function of their respective criticalities to the organization in a window 26 that is divided into four quadratures. The business services are represented by respective circles 28, 30, 32 that are located in the window 26 according to their respective criticality values (horizontal axis) and their security risk (vertical axis). This information enables a business service security manager to easily grasp the risk vs. criticality associated with various business services and to readily identify the business services that are both critical to the business and have a high security risk and therefore are the most urgent to be handled first. For example, a business service security manager viewing the window 26 readily can understand that the business service 28 is at a high risk and a high criticality, whereas the business services 30, 32 are at lower risks and lower criticalities. Based on this information, the business service security manager may decide to provide funds to repair/improve the infrastructure of the business service 28 before allocating funds on the infrastructures of the business services 30, 32.

Referring to FIG. 3B, in some embodiments, the business services risk management system 10 presents on the display 14 a graphical user interface window 44 that shows the risk score 34 of a business service along with a graphical representation of the topology 36 of interconnections between the constituent configuration items 38, 40, 42 that implement the business service. Each of the configuration items 38-42 is associated with a respective ranking score (RS1, RS2, RS3) that indicates the relative contribution of the configuration item to the overall risk score 34 of business service. With this information, a business service security manager can determine the most critical actions that should be taken in order to best improve the security level of the business service.

B. Exemplary Embodiment of a Business Services Risk Management System

FIG. 4 shows an embodiment 50 of the business services risk management system 10 that includes a risk analysis engine 52, a vulnerability assessment tool 54, and a risk modeling engine 56. The risk analysis engine 52 is electronically coupled to the configuration management database (CMDB) 18. The components 52-56 of the business services risk management system 50 may be located in a single computing device or distributed across multiple interconnected computing devices. In some embodiments, the risk analysis engine 52, the vulnerability assessment tool 54, and the risk modeling engine 56 are embodied in a single computing device and the CMDB 18 is embodied in a separate remote computing device.

The risk analysis engine 52 is configured to query the CMDB 18 in order to receive business services models. The query may be a general query requesting all of the business service models stored in the CMDB 18, or it may be a specific query requesting specific business services model related to business sectors, a particular organization. For example, a query may comprise a business service name. The CMDB 18 responds to the query with a reply message that includes the one or more business services models that match the query terms. The business service model indicates all of the CIs that are associated with a particular business service. The business service model also depicts all of the connections (logical and physical) between all of the CIs that are associated with the particular business service. This information may be provided from the CMDB 18 to the risk analysis engine 52 in various formats. For example, the list of CIs and associated relationships may be provided to the risk analysis engine 52 in an XML document or a text document.

After the risk analysis engine 52 has received the one or more business service models from the CMDB 18, the risk analysis engine 52 sends one or more sets of CIs to the vulnerability assessment tool 54, where each set of CIs is associated with a respective business service model. The vulnerability assessment tool 54 may be a security tool or compliance management tool that assesses risks associated with the CIs. In this embodiment, the vulnerability assessment tool 54 is configured to detect all of the vulnerabilities and create a list of vulnerabilities for each CI. In addition, the vulnerability assessment tool 54 is configured to determine a score for each vulnerability, thereby creating a vector of scores (e.g., V₁, V₂, V₃ . . . Vₙ) for each CI. In one embodiment, the score may be based on a common vulnerability scoring system (CVSS). The CVSS is an industry standard for assessing the severity of computer system security vulnerabilities. In other embodiments, the score may be computed using a scoring system that assigns vulnerability scores to IT assets based on a different scoring algorithm.

Once the vulnerability assessment tool 54 has calculated the vector of vulnerability scores (e.g., V₁, V₂, V₃ . . . Vₙ) for a CI, the vulnerability assessment tool 54 sends the vector of vulnerability scores that were calculated for the CI to the risk analysis engine 52. The risk analysis engine 52 determines a single vulnerability score (S_{CIx}) for the CI based on the vector of vulnerability scores (e.g., V₁, V₂, V₃ . . . Vₙ). For example, the single vulnerability score (S_{CIx}) for a particular CI may be determined based on the following function: S_{CIx}=H₁(V₁, V₂, V₃ . . . Vₙ); where S_{CIx} is the single vulnerability score for the particular CI, H₁ is a function, and V₁-Vₙ are the vulnerability scores for the particular CI received from the vulnerability assessment tool 54. In some embodiments, the function H₁ is an averaging function, where S_{CIx} equals the average of the vulnerability scores (V₁, V₂, V₃ . . . Vₙ). For example, if there were three vulnerability scores for a particular CI, S_{CIx} would equal the sum of the three vulnerability scores divided by three. However, this function should not be seen as limiting, as other functions may be used to determine the single vulnerability score (S_{CIx}) for the particular CI. In some embodiments, the vulnerability is a single grade per node that reflects two different factors regarding it: (i) the effort required to compromise the node (the higher the required effort to compromise the node the lower its vulnerability); and (ii) the damage that is caused to the node once it is compromised.

As explained in detail below, the risk analysis engine 52 determines a respective risk score for each business service based on the respective vulnerability scores determined for the constituent configuration items of the business service. In some embodiments, the risk analysis engine 52 also ranks the configuration items in accordance with their respective contributions to the score of the business service. The risk scores and the configuration item rankings are sent to the risk modeling engine 56, which generates respective visualizations of this information that are presented in the graphical user interface 16 on the display 14 (see, e.g., the graphical user interface windows shown in FIGS. 3A and 3B).

C. Scoring a Business Process

1. Overview

In the embodiments described in this section, the RISK score of a business service is defined as the probability of the business service to be damaged. The RISK score of a business service is derived from the following probabilistic model. Let A be the adjacency matrix of the business service that is implemented by a set of configuration items {CIₖ}, where Aᵢⱼ=1 if CIᵢ is connected to CIⱼ and 0 otherwise, and CIᵢ and CIⱼ belong to the business service. The vulnerability of a configuration item (also referred to as “node”) CIᵢ is denoted by vᵢ ∈[0, . . . , 10] and the type classification of the node is denoted by tᵢ ∈[1, . . . , N] (assuming that there are N different types).

The risk scoring function RISK(A,{vᵢ},{tᵢ}) describes the risk of crashes presented to the whole business service. Given two business services A₁,A₂, if RISK(A₁)>RISK(A₂) then A₁ is more vulnerable than A₂. In this way, the risk scoring function enables business process security mangers to search for the actions that are most efficient in improving the total risk score of the business service and to estimate the improvement. The RISK score takes into account the topology of interconnections between the CIs, the vulnerability of the CIs and the types of the CIs in a probabilistic framework as follows:

The node's activity level: Generally speaking, the vulnerability of the business service is expected to be more influenced by nodes that are very active in the transactions involved in the business service. This is because nodes that are more active in transactions are more probable to be compromised. The variable Xᵢ is a random variable that indicates that node CIᵢ is active in business transactions, Xᵢ ∈{T,F}. The probability of the node CIᵢ being active is given by P(Xᵢ=T)=f₁(A,{tⱼ}), where {tⱼ} is the set of all nodes' types, and f₁ is a function that ranks nodes in a graph according to their centrability. An embodiment of the function f1 is described in the next section.

The node's damage probability: The variable Dᵢ is a random variable that indicates that node CIᵢ is compromised, where Dᵢ ∈{T,F}. In this embodiment, the probability of a node to be compromised given that it is active depends only on its vulnerability: P(Dᵢ=T|Xᵢ=T)=f₂(vᵢ), wherein f₂(vᵢ) ∈[0,1]. The vulnerability of the node reflects the probability of it being compromised and damaged. However, the damage probability is not necessarily a linear function of the vulnerability, and the function f₂ is the mapping between the vulnerability of a node and the probability that it is damaged once attacked. This function can be thought of as a transform that maps between “vulnerability” units and “damage probability” units. The function f₂ is a monotonically increasing function and therefore it is invertible. The RISK function also is a monotonic function of each of the node's vulnerabilities (i.e., the more vulnerable a node is, the higher the RISK of the net). In some embodiments, the function f₂(vᵢ) is defined heuristically by the user of the business services risk management system 10.

The node's type: The risk presented to the business service by a failure in one of the nodes is a function of the node's type (e.g. databases are more important than application servers). The variable Rᵢ is a random variable that indicates that the business service is damaged due to a damage in node CIᵢ, Rᵢ ∈{T,F}. The probability of damage to the business service due to a damage in node CIᵢ is given by the function P(Rᵢ=T|Dᵢ=T)=f₃(tᵢ), where f₃(tᵢ) ∈[0,1]. The function f₃ maps between the type of the node and the probability of it to affect the business service once it is damaged. In some embodiments, the function f₃(tᵢ) is defined heuristically by the user of the business services risk management system 10.

2. Calculating an Activity Level of a Configuration Item

The activity level of the node is a function of both the topology of the business service and the node's type. It reflects the amount of accesses (for instance, business transactions) to that node, and the assumption is that the higher the activity level is, the more likely the node is to be compromised. As explained in detail below, the respective activity level of each given one of the configuration items of a business service depends on the configuration items that are connected directly to the given configuration: their activity levels and their classification.

The activity level is computed based on a model in which a transaction performs an infinite series of steps from one CI to another in the business service model. Most of the time, the transition is from one CI to one of its neighbors. With a small probability, the transaction jumps to a random CI. The activity level of a CI is the relative amount of time the transaction spends in this CI, or alternatively, the probability to be in this CI at any point in time.

The transition from one CI to one of its neighbors is a function g(tᵢ) of the types of the neighbors, where g(tᵢ) is a mapping that is controlled by the user. The probability of this transition is given by equation (1):

$$Pr ( {CI}_{i} -> {CI}_{j} \vert {CI}_{j} is a neighbor of {CI}_{i} , transition to a neigbor ) = \frac{g ( {t}_{j} )}{{\sum }_{\{ k \vert {A}_{ik} = 1 \}} g ( {t}_{k} )} \qquad ( 1 )$$

In one example, a business service has three nodes CI₁, CI₂, CI₃ with type classifications [t₁, t₂, t₃], and node CI₁ is linked to two neighbor nodes CI₂, CI₃. It holds also that, t₁=1, t₂=2, t₃=3. In this example, it is assumed that g(t₁)=1, g(t₂)=2, g(t₃)=3. Then,

$$\begin{matrix}Pr ( {CI}_{1} -> {CI}_{2} \vert a transition to a neighbors ) = \frac{2}{5} , and & ( 2 ) \\ Pr ( {CI}_{1} -> {CI}_{3} \vert a transition to a neighbors ) = \frac{3}{5} . & ( 3 )\end{matrix}$$

Formally, the probability of transition from CIᵢ to one of its neighbors is given by 1−m, while the probability of jumping to any other CI in the business service (not necessarily a neighbor of CIᵢ) is m/N, therefore

$$Pr ( {CI}_{i} -> {CI}_{j} ) = \{ \begin{matrix}\frac{m}{N} + ( 1 - m ) \frac{g ( {t}_{j} )}{{\sum }_{\{ k \vert {A}_{ik} = 1 \}} g ( {t}_{k} )} & {A}_{ij} = 1 \\ \frac{m}{N} & {A}_{ij} = 0\end{matrix} \qquad ( 4 )$$

The equilibrium distribution is used to find the activity level of node CIᵢ (which is assumed to be the average amount of time the transaction “spends” in the node). The equilibrium distribution measure is determined based on a centrability score (or importance score) over the topology of the configuration items in the business service, where the model is a random transaction that jumps from one CI to another over the interconnections between the CIs.

In this regard, the variable C ∈ R^{N} is an unknown importance score vector, i.e., c describes the probability of a random transaction to be in CIᵢ at any point in time. Since c is a probability distribution it holds that Σᵢcᵢ=c^{T}e=1 where e is the vector of ones. Writing the transition probabilities in a matrix form produces equation (5):

$$P = ( 1 - m ) RAG + m \frac{1}{N} [ e \cdot {e}^{T} ] , \qquad ( 5 )$$

where G is a diagonal matrix with Gᵢᵢ=g(tᵢ), and R normalizes the rows of AG to have a sum of one, as shown in equation (6):

$$R = \{ \begin{matrix}0 & i \neq j \\ \frac{1}{{\sum }_{k} {AG}_{ik}} & i = j\end{matrix} \qquad ( 6 )$$

Since c is the equilibrium vector it holds that c^{T}P=c^{T} (left eigenvector of P). Simple substitution yields:

$${c}^{T} ( ( 1 - m ) RAG + m \frac{1}{N} [ e \cdot {e}^{T} ] ) = {c}^{T} . \qquad ( 7 )$$

Solving equation (7) gives equation (8):

$${c}^{T} = \frac{m}{N} {{e}^{T} [ 1 - ( 1 - m ) RAG ]}^{- 1} . \qquad ( 8 )$$

The activity level of each node is given by the distribution c.

3. Calculating a RISK Score for a Business Service

The variable R is a random variable that indicates that the business service is damaged, R ∈{T,F}. The RISK score of a business service is defined as the probability of it being damaged by at least one of its nodes, under the constraint that at least one of the nodes is active:

$$\begin{matrix}RISK = P ( R = T \vert At least one of the nodes is active ) & ( 9 ) \\ = \frac{1 - {Π}_{i} \{ 1 - P ( {R}_{i} = T ) \}}{1 - {Π}_{i} ( 1 - P ( {X}_{i} = T ) )} & ( 10 ) \\ = \frac{1 - {Π}_{i} \{ \begin{matrix}1 - P ( {R}_{i} = T \vert {D}_{i} = T ) \cdot \\ P ( {D}_{i} = T \vert {X}_{i} = T ) \cdot P ( {X}_{i} = T )\end{matrix} \}}{1 - {Π}_{i} ( 1 - P ( {X}_{i} = T ) )} & ( 11 ) \\ = \frac{1 - {Π}_{i} \{ 1 - {f}_{i} ( A , \{ {t}_{j} \} ) \cdot {f}_{2} ( {v}_{i} ) \cdot {f}_{3} ( {t}_{i} ) \}}{1 - {Π}_{i} ( 1 - {f}_{1} ( A , \{ {t}_{j} \} ) )} . & ( 12 )\end{matrix}$$

In equation (12), A is an adjacency matrix that describes the interconnections between the configuration items, {vᵢ} are the vulnerability scores of the configuration items, and {tᵢ} are the type classifications, f₁( ) is a function that maps the adjacency matrix A and the type classifications {tᵢ} of the configuration items to the respective activity level of a configuration item, f₂( ) is a function that maps the vulnerability score vᵢ of configuration item i to the respective vulnerability probability value, and f₃( ) is a function that maps the type classification tᵢ of configuration item i to the respective business service risk value.

The RISK score is a probability measure of the business service becoming damaged. In some embodiments, a business service is scored by a BusinessServiceVulnerability function f₂⁻¹ of the RISK score that that maps damage probability to vulnerability, where the function f₂⁻¹ is given by:

BusinessServiceVulnerability=f₂⁻¹(RISK) (13)

The BusinessServiceVulnerability function f₂⁻¹ maps the risk of the business being damaged into a scale of “vulnerability,” which may be more familiar to IT security manages.

D. Ranking Configuration Items of a Business Process

In some embodiments, the RISK function is used to rank the nodes of a business service according to their influence on the total RISK by deriving the function RISK in respect to node vulnerability v. The result is a gradient vector that guides the security managers in selecting which tasks are most efficient:

$$\frac{\partial RISK ( c , v , t )}{\partial {v}_{i}} = {f}_{1} ( A , \{ {t}_{j} \} ) \cdot {f}_{2}^{′} ( {v}_{i} ) \cdot {f}_{3} ( {t}_{i} ) \cdot {\prod }_{j \neq i} \{ 1 - {f}_{1} ( A , \{ {t}_{j} \} ) \cdot {f}_{2} ( {v}_{i} ) \cdot {f}_{3} ( {t}_{i} ) \} \qquad ( 14 )$$

This gradient vector reflects the relative amount of effort that should be invested in each CI in order to best reduce the RISK score of the whole business service. For computational efficiency, this expression can be further modified to obtain:

$$\frac{\partial RISK ( c , v , t )}{\partial {v}_{i}} = \frac{{f}_{1} ( A , \{ {t}_{j} \} ) \cdot {f}_{2}^{′} ( {v}_{i} ) \cdot {f}_{3} ( {t}_{i} ) \cdot {\prod }_{j = 1}^{N} \{ 1 - {f}_{1} ( A , \{ {t}_{j} \} ) \cdot {f}_{2} ( {v}_{j} ) \cdot {f}_{3} ( {t}_{j} ) \}}{\{ 1 - {f}_{1} ( A , \{ {t}_{j} \} ) \cdot {f}_{2} ( {v}_{i} ) \cdot {f}_{3} ( {t}_{i} ) \}} \qquad ( 15 )$$

Since the product Πⱼ₌₁^{N}{1−f₁(A,{tⱼ})·f₂(vⱼ)·f₃(tⱼ)} is common to all gradient components, it can be omitted without changing their ratios.

### III. Exemplary Operating Environment

Embodiments of the business services risk management system 10 may be implemented by one or more discrete modules (or data processing components) that are not limited to any particular hardware, firmware, or software configuration. In the illustrated embodiments, these modules may be implemented in any computing or data processing environment, including in digital electronic circuitry (e.g., an application-specific integrated circuit, such as a digital signal processor (DSP)) or in computer hardware, firmware, device driver, or software. In some embodiments, the functionalities of the modules are combined into a single data processing component. In some embodiments, the respective functionalities of each of one or more of the modules are performed by a respective set of multiple data processing components.

The modules of the business services risk management system 10 may be co-located on a single apparatus or they may be distributed across multiple apparatus; if distributed across multiple apparatus, these modules may communicate with each other over local wired or wireless connections, or they may communicate over global network connections (e.g., communications over the Internet).

In some implementations, process instructions (e.g., machine-readable code, such as computer software) for implementing the methods that are executed by the embodiments of the business services risk management system 10, as well as the data they generate, are stored in one or more machine-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

In general, embodiments of the business services risk management system 10 may be implemented in any one of a wide variety of electronic devices, including desktop computers, workstation computers, and server computers.

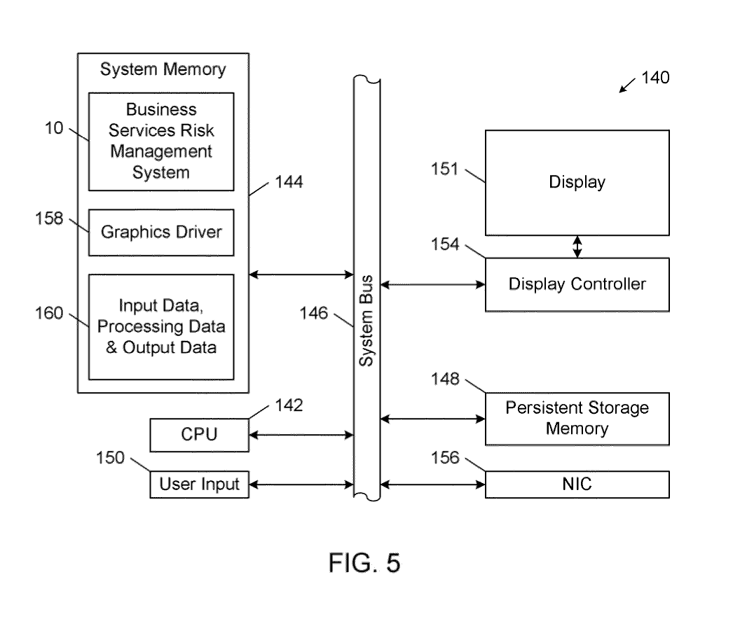

FIG. 5 shows an embodiment of a computer system 140 that can implement any of the embodiments of the business services risk management system 10 that are described herein. The computer system 140 includes a processing unit 142 (CPU), a system memory 144, and a system bus 146 that couples processing unit 142 to the various components of the computer system 140. The processing unit 142 typically includes one or more processors, each of which may be in the form of any one of various commercially available processors. The system memory 144 typically includes a read only memory (ROM) that stores a basic input/output system (BIOS) that contains start-up routines for the computer system 140 and a random access memory (RAM). The system bus 146 may be a memory bus, a peripheral bus or a local bus, and may be compatible with any of a variety of bus protocols, including PCI, VESA, Microchannel, ISA, and EISA. The computer system 140 also includes a persistent storage memory 148 (e.g., a hard drive, a floppy drive, a CD ROM drive, magnetic tape drives, flash memory devices, and digital video disks) that is connected to the system bus 146 and contains one or more computer-readable media disks that provide non-volatile or persistent storage for data, data structures and computer-executable instructions.

A user may interact (e.g., enter commands or data) with the computer 140 using one or more input devices 150 (e.g., a keyboard, a computer mouse, a microphone, joystick, and touch pad). Information may be presented through a user interface that is displayed to a user on the display 151 (implemented by, e.g., a display monitor), which is controlled by a display controller 154 (implemented by, e.g., a video graphics card). The computer system 140 also typically includes peripheral output devices, such as speakers and a printer. One or more remote computers may be connected to the computer system 140 through a network interface card (NIC) 156.

As shown in FIG. 5, the system memory 144 also stores the business services risk management system 10, a graphics driver 158, and processing information 160 that includes input data, processing data, and output data. In some embodiments, the business services risk management system 10 interfaces with the graphics driver 158 (e.g., via a DirectX® component of a Microsoft Windows® operating system) to present a user interface on the display 151 for managing and controlling the operation of the business services risk management system 10.

### IV. Conclusion

The embodiments that are described herein provide improved systems and methods of managing business services risk that fuses business services data and creates a reliable and simple representation of the security situation. These embodiments leverage a unique probabilistic framework that combines business service topology structure with security measures and provides for each business service a single respective risk metric that represents the security level of the business service. In some of these embodiments, the probabilistic framework is used to determine a ranking of the configuration items of the business service and determine the most urgent security critical missions.

Other embodiments are within the scope of the claims.

1. A method, comprising:
receiving a business service model comprising a description of a topology of interconnections between configuration items that implement a business service, wherein each of the configuration items is associated with a respective vulnerability score and a respective type classification;
based on the vulnerability scores and the type classifications, determining for each of the configuration items a respective activity level value indicating a probability of the configuration item being active in the business service, a respective vulnerability probability value indicating a probability of the configuration items being compromised and damaged in the business service, and a respective business service risk value indicating a probability of a failure of the business service resulting from damage of the configuration item; and
scoring the business service based on the activity level values, the vulnerability values, and the business service risk values;
wherein the receiving, the determining, and the scoring are performed by a |computer|_{[Al].}

2. The method of claim 1, wherein the scoring comprises deriving from the activity level values, the vulnerability values, and the business service risk values a risk score indicating a probability of the business service being damaged.

3. The method of claim 1, wherein the scoring comprises evaluating a function R( ) given by:
$$R ( A , \{ {v}_{i} \} , \{ {t}_{i} \} ) = \frac{1 - {Π}_{i} \{ 1 - {f}_{1} ( A , \{ {t}_{j} \} ) \cdot {f}_{2} ( {v}_{i} ) \cdot {f}_{3} ( {t}_{i} ) \}}{1 - {Π}_{i} ( 1 - {f}_{1} ( A , \{ {t}_{j} \} ) )} ,$$
wherein A is an adjacency matrix that describes the interconnections between the configuration items, {vᵢ} are the vulnerability scores of the configuration items, and {tᵢ} are the type classifications, f₁( ) is a function that maps the adjacency matrix A and the type classifications {tᵢ} of the configuration items to the respective activity level of a configuration item, f₂( ) is a function that maps the vulnerability score vᵢ of configuration item i to the respective vulnerability probability value, and f₃( ) is a function that maps the type classification tᵢ of configuration item i to the respective business service risk value.

4. The method of claim 1, wherein the determining comprises ascertaining the respective activity level of each of the configuration items based on the type classifications of the configuration items and the topology of interconnections between the configuration items.

5. The method of claim 4, wherein the ascertaining comprises ascertaining the respective activity level of each given one of the configuration items based on a respective count of the configuration items that are connected directly to the given configuration item, the classification types of the configuration items that are connected directly to the given configuration item, and the topology of interconnections between all the configuration items.

6. The method of claim 1, wherein the determining comprises determining the respective vulnerability probability value of each of the configuration items based on a mapping of the respective vulnerability score of the configuration item to the respective vulnerability probability value.

7. The method of claim 1, wherein the determining comprises determining the respective business service risk value based on a mapping of the respective classification type of the configuration item to the respective business service risk value.

8. The method of claim 1, wherein the scoring comprises ascertaining a score for the business service based on a function that maps the type classifications of the configuration items and the topology of interconnections between the configuration items to the score, and further comprising ranking the configuration items in accordance with their respective contributions to the score of the business service.

9. The method of claim 8, wherein the ranking comprises determining for each of the configuration items a respective value of a gradient of the function with respect to the respective vulnerabilities of the configuration items, and the ranking the configuration items based on the respective gradient function values.

10. At least one computer-readable medium having computer-readable program code embodied therein, the computer-readable program code adapted to be executed by a computer to implement a method comprising:
receiving a business service model comprising a description of a topology of interconnections between configuration items that implement a business service, wherein each of the configuration items is associated with a respective vulnerability score and a respective type classification;
based on the vulnerability scores and the type classifications, determining for each of the configuration items a respective activity level value indicating a probability of the configuration item being active in the business service, a respective vulnerability probability value indicating a probability of the configuration items being compromised and damaged in the business service, and a respective business service risk value indicating a probability of a failure of the business service resulting from damage of the configuration item; and
scoring the business service based on the activity level values, the vulnerability values, and the business service risk values.

11. The at least one computer-readable medium of claim 10, wherein the scoring comprises evaluating a function R( ) given by:
$$R ( A , \{ {v}_{i} \} , \{ {t}_{i} \} ) = \frac{1 - {Π}_{i} \{ 1 - {f}_{1} ( A , \{ {t}_{j} \} ) \cdot {f}_{2} ( {v}_{i} ) \cdot {f}_{3} ( {t}_{i} ) \}}{1 - {Π}_{i} ( 1 - {f}_{1} ( A , \{ {t}_{j} \} ) )} ,$$
wherein A is an adjacency matrix that describes the interconnections between the configuration items, {vᵢ} are the vulnerability scores of the configuration items, and {tᵢ} are the type classifications, f₁( ) is a function that maps the adjacency matrix A and the type classifications {tᵢ} of the configuration items to the respective activity level of a configuration item, f₂( ) is a function that maps the vulnerability score vᵢ of configuration item i to the respective vulnerability probability value, and f₃( ) is a function that maps the type classification tᵢ of configuration item i to the respective business service risk value.

12. The at least one computer-readable medium of claim 10, wherein the determining comprises ascertaining the respective activity level of each of the configuration items based on the type classifications of the configuration items and the topology of interconnections between the configuration items.

13. The method of claim 12, wherein the ascertaining comprises ascertaining the respective activity level of each given one of the configuration items based on a respective count of the configuration items that are connected directly to the given configuration item, the classification types of the configuration items that are connected directly to the given configuration item, and the topology of interconnections between all the configuration items.

14. The at least one computer-readable medium of claim 10, wherein the scoring comprises ascertaining a score for the business service based on a function that maps the type classifications of the configuration items and the topology of interconnections between the configuration items to the score, and further comprising ranking the configuration items in accordance with their respective contributions to the score of the business service.

15. The at least one computer-readable medium of claim 14, wherein the ranking comprises determining for each of the configuration items a respective value of a gradient of the function with respect to the respective vulnerabilities of the configuration items, and the ranking the configuration items based on the respective gradient function values.

16. Apparatus, comprising:
a computer-readable medium storing computer-readable instructions; and
a processor coupled to the computer-readable medium, operable to execute the instructions, and based at least in part on the execution of the instructions operable to perform operations comprising
receiving a business service model comprising a description of a topology of interconnections between configuration items that implement a business service, wherein each of the configuration items is associated with a respective vulnerability score and a respective type classification;
based on the vulnerability scores and the type classifications, determining for each of the configuration items a respective activity level value indicating a probability of the configuration item being active in the business service, a respective vulnerability probability value indicating a probability of the configuration items being compromised and damaged in the business service, and a respective business service risk value indicating a probability of a failure of the business service resulting from damage of the configuration item; and
scoring the business service based on the activity level values, the vulnerability values, and the business service risk values.

17. The apparatus of claim 16, wherein in the scoring the processor is operable to perform operations comprising evaluating a function R( ) given by:
$$R ( A , \{ {v}_{i} \} , \{ {t}_{i} \} ) = \frac{1 - {Π}_{i} \{ 1 - {f}_{1} ( A , \{ {t}_{j} \} ) \cdot {f}_{2} ( {v}_{i} ) \cdot {f}_{3} ( {t}_{i} ) \}}{1 - {Π}_{i} ( 1 - {f}_{1} ( A , \{ {t}_{j} \} ) )} ,$$
wherein A is an adjacency matrix that describes the interconnections between the configuration items, {vᵢ} are the vulnerability scores of the configuration items, and {tᵢ} are the type classifications, f₁( ) is a function that maps the adjacency matrix A and the type classifications {tᵢ} of the configuration items to the respective activity level of a configuration item, f₂( ) is a function that maps the vulnerability score vᵢ of configuration item i to the respective vulnerability probability value, and f₃( ) is a function that maps the type classification tᵢ of configuration item i to the respective business service risk value.

18. The apparatus of claim 16, wherein in the determining the processor is operable to perform operations comprising ascertaining the respective activity level of each given one of the configuration items based on a respective count of the configuration items that are connected directly to the given configuration item, the classification types of the configuration items that are connected directly to the given configuration item, and the topology of interconnections between all the configuration items.

19. The apparatus of claim 16, wherein in the scoring the processor is operable to perform operations comprising ascertaining a score for the business service based on a function that maps the type classifications of the configuration items and the topology of interconnections between the configuration items to the score, and further comprising ranking the configuration items in accordance with their respective contributions to the score of the business service.

20. The apparatus of claim 19, wherein in the ranking the processor is operable to perform operations comprising determining for each of the configuration items a respective value of a gradient of the function with respect to the respective vulnerabilities of the configuration items, and the ranking the configuration items based on the respective gradient function values.
